(19) United States
(12) Patent Application Publication
(10) Pub. No.: US 2005/0052035 A1
(43) Pub. Date: Mar. 10, 2005

(54) Door security latch

(76) Inventor: Chikara Yamashita, Tokyo (JP)

Correspondence Address: Randy Shay, PO Box 2607, Fairfax, VA, 22031, US

(21) Appl. No.: 10/656,215

(22) Filed: Sep. 8, 2003

(51) Int. Cl. E05C 17/04

(52) U.S. Cl. 292/262

(57) ABSTRACT

An improved door security latch is disclosed in which the range of motion of a secured door is variable depending on the degree to which the latch is engaged. Like most prior art latches, an arm with a substantially spherical member is mounted to the inside surface of a door such that the arm extends beyond the free edge of the door. A pivotable first yoke mounted to the door frame engages the arm and substantially spherical member such that as the arm travels along the first yoke, the substantially spherical member constrains the arm within the first yoke, limiting the doors swing to the length of the first yoke. The present invention adds a second yoke which engages the substantially spherical member more closely, limiting the swing of the door to a fraction of an inch.

### BACKGROUND OF THE INVENTION

1. Field of the Invention

The present invention relates to security latches as are typically found on doors in private quarters in public or semi-public buildings, such as hotels and motels. More particularly, the invention comprises an improved security latch which, optionally, allows the door to be opened a determined distance before stopping further swing or prevent the door from being opened beyond only a fraction of an inch.

2. Description of the Prior Art

Personal security in private quarters in public or semi-public buildings, such as hotels and motels has long been a concern to residents of such facilities. Easily installable and used latches which limit the distance that a door may be opened have been known in the art for many years, but by allowing the door to be partially opened, these latches have been susceptible to cutting or forcing, thereby allowing entry. In more recent years, forcible entry has become more prevalent, therefore improved protection from cutting or forcing has become desirable.

In the prior art, there are a variety of different disclosures of security latches for doors and windows, including:
U.S. Pat. No. 4,684,159, issued to Richard E. Moore on Aug. 4, 1987, which presents a SAFETY LATCH FOR DOORS AND SIMILAR STRUCTURES;
U.S. Pat. No. 4,436,331, issued to Howard E. Glickman, et al., on Mar. 13, 1984, which discloses a MULTIPLE-POSITION HASP-TYPE DOOR CHECK;
U.S. Pat. No. 4,229,030, issued to Francisco J. Tarragona Corbella on Oct. 21, 1980, discloses a SAFETY DOOR FASTENING;
A DOOR SAFETY LATCH is disclosed in U.S. Pat. No. 4,062,578, issued to Trevor G. Chen on Dec. 13, 1977;
U.S. Pat. No. 2,442,773, issued to F. M. Schultz on Jun. 1, 1948, discloses a DOOR SAFETY LATCH;
L. H. Gorowitz discloses a FASTENER FOR DOORS AND THE LIKE in U.S. Pat. No. 1,497,500, issued on Jun. 10, 1924;
A DOOR CHECK is disclosed in U.S. Pat. No. 622,556, issued on Apr. 4, 1899, to J. Spiers;
U.S. Pat. No. 534,716, issued on Feb. 26, 1895, to W. C. Hillgendorf discloses a DOOR SECURER; and
A DOOR CHECK is disclosed in U.S. Pat. No. 215,900, issued on May 27, 1879, to J. P. Ellacott.

In each of the above cited disclosures, a door is secured in a generally closed state while allowing up to three or four inches of swing to see who is on the other side. None of these cited disclosures, however, provides for a second, lesser degree of opening of the door, thereby preventing the forcing of the door or cutting of the latch, as does the present invention.

None of the above inventions and patents, taken either singly or in combination, is seen to describe the instant invention as claimed.

### SUMMARY OF THE INVENTION

The present invention provides an improved security latch for use in private quarters in public or semi-public buildings, such as hotels and motels. While a variety of security latches have been disclosed in the past, most have been susceptible to cutting or forcing due to the very intent of allowing a door to be partially opened while secured from fully opening. Once the door latch has been opened and the door allowed to swing partially open, most latches may be broken or forced from their anchors by exerting pressure on the door with a shoulder or such. Likewise, once the door is ajar, a bolt cutter or, similar device, may be slipped into the open doorway to cut the chain or bar of most latches. The present invention improves upon these prior art latches by, optionally, preventing the door from being opened beyond a fraction of an inch, thereby eliminating the potential to force the door open or interject a bolt cutter into the opening. The present invention adds a second yoke which can be engaged over the substantially spherical member of the latch after engaging the arm such that minimal travel of the door is allowed when engaged.

Accordingly, it is a principal object of the invention to provide a door security latch which is easy to use.

It is another object of the invention to provide a door security latch which is easy to install.

Another object of the invention is to provide a door security latch which is strong and durable.

It is a further object of the invention to provide a door security latch which allows a door to be opened by a determined distance while limiting the swing to that determined distance.

Yet another object of the invention is to provide a door security latch which may be used to prevent a door from closing completely and latching, thereby locking an occupant out of a room.

Still another object of the invention is to provide a door security latch which may, optionally, prevent the door from being opened beyond a fraction of an inch, thereby preventing the potential for forcing the door open or inserting a cutting device into the opening to cut the latch.

An additional object of the invention is to provide a door security latch which is economical to produce and therefore install.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of the door plate of the present invention with the arm in a first, extended, position.

FIG. 2 is a perspective view of the door plate of the present invention with the arm in a second, retracted, position.

FIG. 3 is a perspective view of the jamb plate of the present invention with the first yoke in a first, engaged, position and the second yoke in a first, retracted, position.

FIG. 4 is a perspective view of the jamb plate of the present invention with the first yoke in a first, engaged, position and the second yoke in a second, engaged position.

FIG. 5 is a perspective view of the jamb plate of the present invention with the first yoke in a second, retracted position.

FIG. 6 is a perspective view of the jamb plate and the door plate of the present invention with the first yoke in a first, engaged, position and the second yoke in a second, retracted, position.

FIG. 7 is a perspective view of the jamb plate and door plate of the present invention, with the door opened to the limit of the first yoke.

FIG. 8 is a perspective view of the jamb plate and door plate with the first yoke and the second yoke in their respective engaged positions and the door opened to the limit of the second yoke.

FIG. 9 is a perspective view of the jamb plate and the door plate depicting an additional embodiment of the arm and second yoke.

### DETAILED DESCRIPTION OF THE PREFERRED EMBODIMENTS

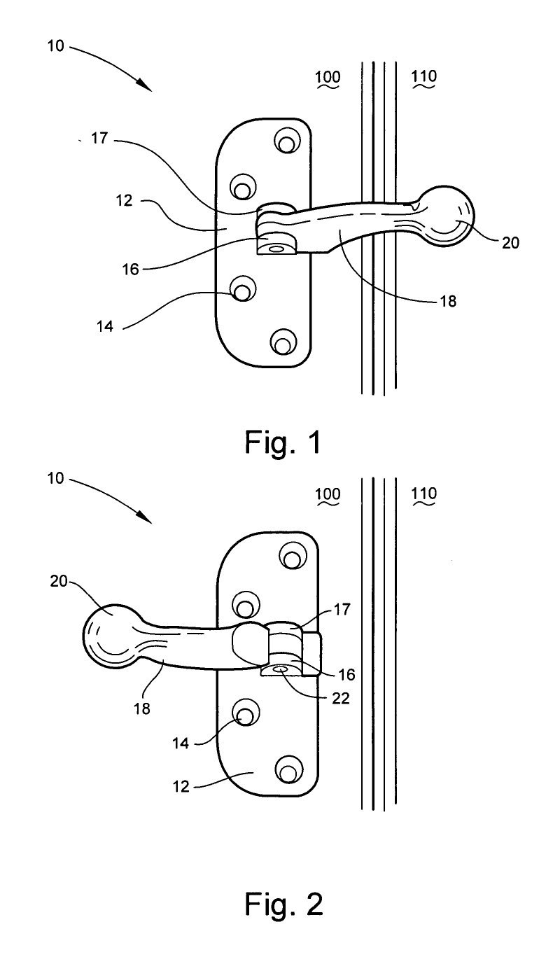

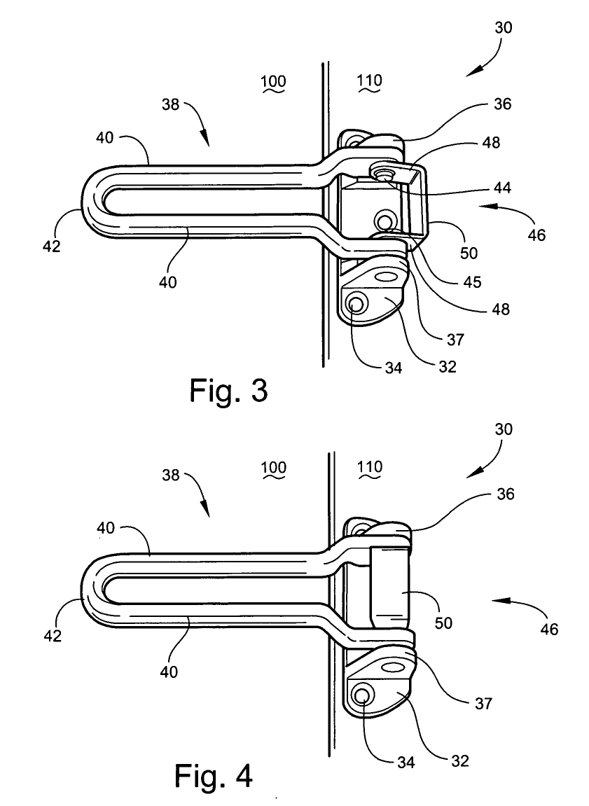

Referring to FIGS. 1 through 8 wherein like numbers are used to designate like parts, the door security latch 1 of the present invention generally consists of a door element 10 and a jamb element 30 which cooperate to prevent the door on which installed from being opened beyond a determined distance.

The door element 10 consists of a generally elongate, flat metal base plate 12 with a plurality of holes 14 proximate the perimeter thereof. Holes 14 are countersunk from a front face of base plate 12. A pair of lugs 16 and 17, parallel to and spaced apart from one another extend substantially normal to the front face of base plate 12 proximate the center of base plate 12. The length of lugs 16, 17 lies substantially parallel to the upper and lower edges base plate 12. A projecting arm 18 extends out and angularly away from the front face base plate 12 at the lugs 16, 17, extending beyond a first lateral side of the perimeter of base plate 12. Arm 18 terminates in a substantially spherical member 20, substantially spherical member 20 having a diameter greater than the width of arm 18. Arm 18 is journaled between lugs 16, 17 by a pin 22 such that arm 18 is retractable from the first lateral edge of base plate 12 to the second lateral edge. Door element 10 is affixed to the free side of the interior surface of a door 100, typically above the door knob, by means of screws (not shown), such that the arm 18 and substantially spherical member 20 extend beyond the free edge of the door 100.

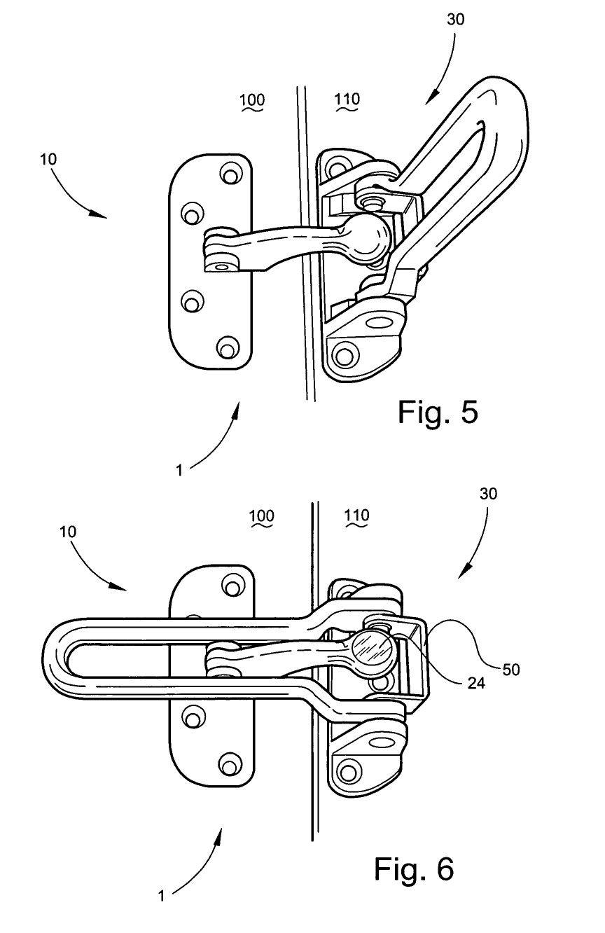

Jamb element 30, like door element 10 is based on a generally elongate, flat metal base plate 32 with a plurality of holes 34 proximate the perimeter thereof. Holes 34 are, again, countersunk from a front face of base plate 32. A pair of lugs 36 and 37, parallel to and spaced apart from one another extend substantially normal to the front face of flat plate 32. The length of lugs 36, 37 lies substantially parallel to the upper and lower edges sides of the base plate 32. A first yoke 38, having a distal end and a proximal end, is pivotally attached, at its proximal end, between the lugs 36, 37. First yoke 38 consists of a pair of first yoke side rails 40, substantially parallel to one another and joined at their distal end by first yoke distal rail 42. The space between the first yoke side rails 40 is slightly greater than the width of arm 18, but less than the diameter of substantially spherical member 20. At their proximal end, first yoke side rails 40 extend apart from one another to a distance slightly greater than the diameter of substantially spherical member 20. First yoke 38 is journeled from lugs 36, 37 by pins 44, 45. Jamb element 30 is attached to the door door jamb 110 by means of screws (not shown) such that substantially spherical member 20 of door element 10 rests between the proximal ends of the first yoke side rails 40 of first yoke 38 when first yoke 38 is swung back to the retracted position (FIG. 5).

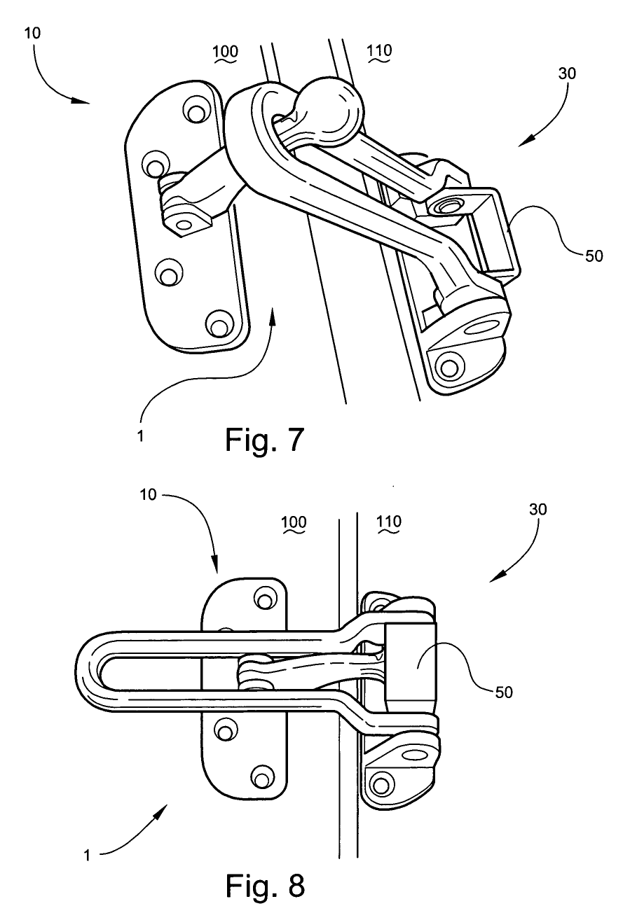

To this point, the present invention is quite similar to prior art latches, such as U.S. Pat. No. 4,062,578, issued on Dec. 13, 1977. As has been previously described, door element 10 is mounted to a door 100 such that the arm 18 and substantially spherical member 20 extend beyond the free side of the door 100 such that the substantially spherical member 20 rests between the proximal ends of the first yoke side rails 40 of first yoke 38 and lugs 36, 37 when the first yoke 38 is swung back to a retracted position. When the door 100 is in a closed state, the first yoke 38 can be closed over the substantially spherical member 20 of the door element 10 (FIG. 6). If the door is opened, the arm 18 of the door element 10 can slide between the first yoke side rails 40 of the first yoke 38 to the distal end of first yoke 38 and first yoke distal rail 42. Substantially spherical member 20 prevents first yoke 38 from slipping from arm 18, thus the door 100 may be opened only to the length of first yoke 38 (FIG. 7). When the door 100 is again closed, the first yoke 38 may swung back to a retracted position, releasing substantially spherical member 20, allowing the door to be opened to its full swing.

The present invention goes beyond the prior art in the inclusion of a second yoke 46 pivotally attached to the lugs 36, 37 of jamb element 30. Second yoke 46 has a pair of second yoke side rails 48, substantially parallel to one another and spaced apart from one another by a distance slightly greater than the diameter of substantially spherical member 20. Second yoke 46 is pivotally attached to the lugs 36, 37 at the proximal ends of second yoke side rails 48 by the same pivot pins 44, 45 as is first yoke 38. The side rails 46 are joined at their distal end by a second yoke distal rail 50, such that, when in the closed state, second yoke distal rail 50 of second yoke 46 constrains substantially spherical member 20 closely. When engaged, second yoke 46 prevents door 100 from being opened beyond the close limit of second yoke 46 (FIG. 8).

In the above described embodiment, door security latch 1 allows a user to, optionally, constrain the distance to which a door may be opened to the length of first yoke 38, thereby allowing gap between the edge of door 100 and door jamb 110, or to the lesser distance of the length of second yoke 46.

In a second embodiment (FIG. 6), substantially spherical member 20 has a flattened surface 24 at a front portion thereof, which may more closely engage second yoke distal rail 50 of second yoke 46 to reduce the possibility of disengaging the second yoke 46 by jiggling the door 100 from the outside.

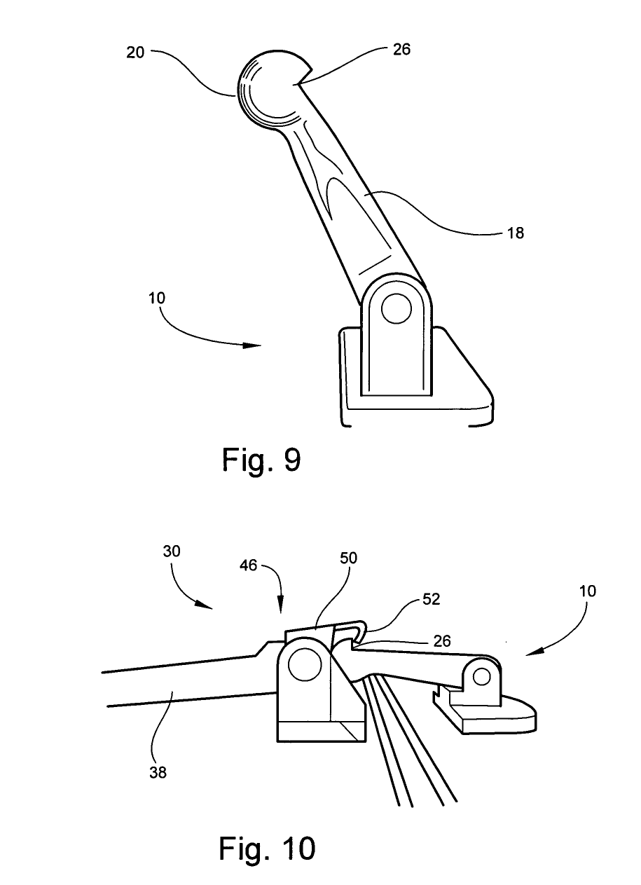

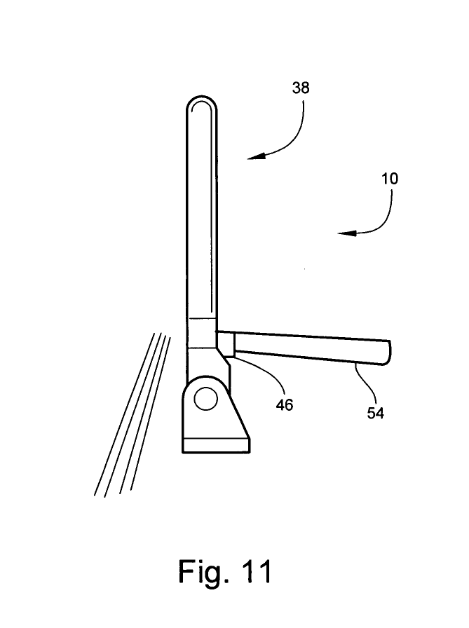

In a third embodiment (FIGS. 9 and 10), substantially spherical member 20 has a notch 26 cut into a front portion thereof. Distal rail 50 of second yoke 46 incorporates a lip 52 which engages notch 26 when second yoke 46 is in the engaged position, thereby reducing, to an even greater degree, the possibility of disengaging the second yoke 46 by jiggling the door 100 from the outside.

Since the locks on hotel and motel doors are typically set to lock when the door is closed, occupants often use the device corresponding to first yoke 38 of the present invention to prevent the door from closing completely when they leave the room. This is accomplished by opening the door, then moving the yoke to the engaged position, thereby placing the yoke between the free edge of door 100 and door jamb 110. In any of the above cited embodiments of the present invention, second yoke 46 may further include a hard plastic or rubber sheathed metal tongue 54 (FIG. 11) which extends beyond second yoke distal rail 50 to prevent door 100 from closing completely. The hard plastic or rubber sheathing provides protection from marring to the free edge of door 100 and door jamb 110. Optionally, the first yoke side rails 40 and distal rail 42 may be rubber sheathed (not shown), to also serve as a tongue 54.

It is to be understood that the present invention is not limited to the embodiments described above, but encompasses any and all embodiments within the scope of the following claims.

1. A door security latch comprising:
a jamb element, said jamb element further comprising:
a jamb base plate,
first constraining means for limiting the distance to which a door may be opened to a first opening distance, and
second constraining means for limiting the distance to which a door may be opened to a second distance being smaller than said first opening distance; and
a door element, said door element further comprising:
a door base plate,
engaging means for engaging either said first constraining means of said jamb element or said second constraining means of said jamb element or both said first constraining means and said second constraining means depending upon which of said constraining means is engaged, and
retaining means for maintaining said constraint means within said first engaging means and said second engaging means.

2. A door security latch, as defined in claim 1, wherein said engaging means comprises a projecting arm extending, at a first end, out and angularly away from proximate the center of a front face of said door base plate to a distal end located at a point beyond a first lateral side of the perimeter of said door base plate and a free edge of a door, said arm having a given thickness.

3. A door security latch, as defined in claim 2, wherein said first constraining means comprises a first yoke, pivotally attached at its proximal end to lugs on a front face of said jamb base plate and having a pair of first yoke side rails substantially parallel to one another and joined by a first yoke distal rail at their distal ends, said first yoke side rails being spaced apart by a distance greater than said thickness of said arm but less than said diameter of said substantially spherical member, said first yoke side rails extending apart from one another at their proximal ends to a distance greater than said diameter of substantially spherical member.

4. A door security latch, as defined in claim 3, wherein said retaining means comprises a substantially spherical member at said distal end of said arm, said substantially spherical member having a diameter greater than said thickness of said arm.

5. A door security latch, as defined in claim 4, wherein said arm is pivotally attached to said door base plate.

6. A door security latch, as defined in claim 5, wherein said second constraining means comprises a second yoke having a pair of second yoke side rails having proximal and distal ends and being substantially parallel to one another and spaced apart at a distance slightly greater than the diameter of substantially spherical member, joined to one another at said distal ends by a second yoke distal rail, and being pivotally attached to said jamb base plate at an axis coinciding with the axis of attachment of said first yoke, such that, when in a closed state, said second yoke constrains said substantially spherical member closely, thereby preventing said door from being opened beyond a minimal distance.

7. A door security latch, as defined in claim 4, wherein said substantially spherical member has a flattened surface at a front portion thereof.

8. A door security latch, as defined in claim 7, wherein said arm is pivotally attached to said door base plate.

9. A door security latch, as defined in claim 8, wherein said second constraining means comprises a second yoke having a pair of second yoke side rails having proximal and distal ends and being substantially parallel to one another and spaced apart at a distance slightly greater than the diameter of substantially spherical member, joined to one another at said distal ends by a second yoke distal rail, and being pivotally attached to said jamb base plate at an axis coinciding with the axis of attachment of said first yoke, such that, when in a closed state, said second yoke constrains said substantially spherical member closely, thereby preventing said door from being opened beyond a minimal distance.

10. A door security latch, as defined in claim 4, wherein said substantially spherical member has a notch formed in a front portion thereof.

11. A door security latch, as defined in claim 10, wherein said arm is pivotally attached to said door base plate.

12. A door security latch, as defined in claim 11, wherein said second constraining means comprises a second yoke having a pair of second yoke side rails having proximal and distal ends and being substantially parallel to one another and spaced apart at a distance slightly greater than the diameter of substantially spherical member, joined to one another at said distal ends by a second yoke distal rail, and being pivotally attached to said jamb base plate at an axis coinciding with the axis of attachment of said first yoke, such that, when in a closed state, said second yoke further comprising a lip, said lip adapted to engage said notch of said substantially spherical member, thereby preventing said door from being opened beyond a minimal distance.

13. A door security latch, as defined in claim 1 wherein said jamb element further comprises a tongue, said tongue being pivotally attached to said jamb base plate and adapted to be inserted between a free edge of a door and a door jamb to prevent said door from closing fully and thereby locking.

14. A door security latch, as defined in claim 1 wherein said jamb element further comprises a tongue, said tongue being pivotally attached to said jamb base plate and adapted to be inserted between a free edge of a door and a door jamb to prevent said door from closing fully and thereby locking.

15. A door security latch, as defined in claim 1 wherein said jamb element further comprises a tongue, said tongue being pivotally attached to said jamb base plate and adapted to be inserted between a free edge of a door and a door jamb to prevent said door from closing fully and thereby locking.

16. A door security latch, as defined in claim 13, wherein said tongue is formed of at least one material from the group: a hard plastic and a rubber sheathed metal.

17. A door security latch, as defined in claim 14, wherein said tongue is formed of at least one material from the group: a hard plastic and a rubber sheathed metal.

18. A door security latch, as defined in claim 15, wherein said tongue is formed of at least one material from the group: a hard plastic and a rubber sheathed metal.
